(19) United States
(12) Patent Application Publication
(10) Pub. No.: US 2009/0023024 A1
(43) Pub. Date: Jan. 22, 2009

(54) Fuel cell stack

(75) Inventors: Amedeo Conti, Mariano Comense (IT); Antonino Toro, Segrate (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: NUVERA FUEL CELLS EUROPE S.R.L., S. Donato Milanese (IT)

(21) Appl. No.: 11/664,672

(22) PCT Filed: Feb. 5, 2007
(86) PCT No.: PCT/EP07/51086

§ 371 Date: Apr. 4, 2007

(30) Foreign Application Priority Data
Feb. 6, 2006 (IT) MI 2006 A 000197

(51) Int. Cl. H01M 8/04; H01M 2/02

(52) U.S. Cl. 429/26; 429/34

(57) ABSTRACT

A membrane fuel cell stack comprising metal current-collecting plates of high electrical conductivity made of aluminum or copper, having a reduced planform with respect to the one of the elementary cells, the galvanic-type corrosion phenomena affecting the current-collecting plates of the prior art and the consequent metal ion release in the circulating water are overcome.

Fuel cells are a known direct conversion device of the chemical energy of recombination of a fuel such as hydrogen with an oxidant such as air to electrical energy. Fuel cells are not subject to the known Carnot's cycle limitation and are therefore characterised by a particularly high efficiency compared to that of the conventional devices for the production of electrical energy in which an intermediate thermal stage is present.

Among the several known types the cation-exchange membrane fuel cell (for the sake of conciseness hereafter indicated by the acronym PEMFC from Proton Exchange Membrane Fuel Cell) has gained a special attention for its capability of responding to quick power requests and for the simplicity of the associated auxiliaries, particularly in automotive applications and for the generation of small stationary power for domestic uses or for small communities.

The PEMFC consists of an electrochemical unit comprising an ionomeric membrane (for instance of the hydrocarbon type, derived from polymers such as polystyrene or polyetheretherketones, or of the perfluorinated type as commercialised for instance by DuPont, USA under the trade-mark Nafion®), on whose faces are applied two electrodes, anode (negatively charged) and cathode (positively charged), in form of porous films containing suitable catalysts. The external surfaces of the electrodes are in their turn in contact with generally planar structures suitable for establishing an optimal electrical conduction and a homogeneous distribution of the gaseous reactants, known as diffusers. The overall assembly resulting from the electrochemical unit associated to the diffusers (commonly identified by the acronym MEA from Membrane Electrode Assembly) is finally enclosed between a pair of bipolar plates, positive and negative, consisting of two suitably shaped plates, impervious to the reactants and provided with electrical conductivity. The fuel, in the most common case hydrogen, either pure or in admixture, and the oxidant, in the most common case air, are supplied through suitable openings obtained in the bipolar plates and reach respectively the anode and the cathode through the diffusers. Hydrogen is oxidised with generation of electrons and protons which migrate through the ionomeric membrane and participate to the reduction reaction of the oxygen of air with formation of water. The electrons required for the reduction reaction come from the anode through an external electrical energy user circuit. The voltage of a single fuel cell under current generation conditions is normally comprised between 0.5 and 0.8 Volts: in order to obtain the high voltages commonly required by the user appliances, a multiplicity of typically 50 to 200 elementary cells laminated according to a modular arrangement of the filter-press type into a stack is employed. Since the bipolar plates are normally interchangeable and the relevant openings are superposable, the lamination of the elementary cells determines the formation of internal longitudinal manifolds which allow feeding the gaseous reactants to the individual cells and extracting the exhausts. In correspondence of the positive terminal pole and of the negative terminal pole of the multiplicity of elementary cells, two current-collecting plates suitable for ensuring the connection to the external electrical circuit with a minimum ohmic drop are installed: for this reason the two current-collecting plates are made of materials with high electrical conductivity, typically aluminium or copper, and have a suitable thickness. The multiplicity of elementary cells/current-collecting plate assembly is finally enclosed between two terminal plates which maintain the assembly under compression in co-operation with tie-rods or other tightening devices known in the art, so as to guarantee that the electrical contact between each pair of elementary cells of the multiplicity is optimal, and that the peripheral gaskets of each elementary cell ensure the required sealing to the external environment.

The conversion efficiency of the chemical energy of reaction to electrical energy typical of the fuel cells, although substantially higher than that of the conventional generators, is largely below 100%: the portion of chemical energy not converted to electrical energy is transformed to thermal energy which has to be extracted in order to maintain the cell internal temperature around 60-100° C.: such a result may be obtained by forced air circulation, usually in low power systems, or by coolant circulation for systems of higher power. Since the combination reaction of hydrogen with the oxygen contained in the air produces water, the latter is collected, according to a generally applied solution, in suitable tanks to be employed as coolant in accordance with two distinct technologies, namely by indirect cooling through the passage across suitable devices intercalated to the elementary cells or by direct injection inside the elementary cells. The stack is provided with nozzles for feeding and extracting water secured to one of the two terminal plates or both and connected to an external circuit comprising collecting tanks, circulation pump, filters and suitable ducts.

A further commonly adopted measure to ensure the correct PEMFC operation is represented by the pre-humidification of the gas feed with the purpose of ensuring a membrane hydration level suitable for allowing a high proton migration and therefore a low ohmic resistance and a higher operating voltage; this assumes a particular importance in case the previously mentioned cell cooling is not carried out by direct water injection.

The internal design of the stacks manufactured according to the prior art implies that the water comes in contact with the different system components, in particular the bipolar plates, the membrane, the current-collecting plates, the tanks, the filters, the circulating pumps and the ducts of the external circuit.

Many of these parts are metallic and are therefore subject, also as a consequence of the peculiar electrical situations typical of the system, to release ions, in particular aluminium and copper ions as concerns the current-collecting plates, which are progressively concentrated in the circulating water. In the zones of the system where the water comes in contact with the membranes, the metal ions are absorbed because the membrane polymer acts effectively as an ion-exchange resin, with a progressive proton transport loss associated to a lessening of the operative voltage.

The enrichment may be limited by installing a cartridge containing cation-exchange resins in the water circuit or alternatively by the measures disclosed in WO 2005/031900, consisting of modifications of the membrane periphery and variations of the geometry of the internal longitudinal ducts for distributing the water to the elementary cells. Such measures imply management or manufacturing complications and proved not resolutive, particularly as regards the metal ion release by the current-collecting plates.

It is a first object of the present invention to provide a stack design overcoming the limitations of the prior art, in particular solving the problem of the metal ion release by the current-collecting plates and of the associated phenomena of time decay of the performances.

This and other objects will be clarified by the following description and the annexed drawings, which are not intended to constitute a limitation of the invention.

In accordance with what is proposed in the present invention, the first object is accomplished by a stack having the features indicated in claim 1.

The stack according to the invention consists of a multiplicity of elementary fuel cells comprising current-collecting plates isolated from the process fluids, having a reduced planform with respect to the planform.

By reduced planform of the current-collecting plates it is intended, in the present description, that the geometrical projection of the surface of the current-collecting plate onto that of the bipolar plates delimiting the elementary cells defines an overlapping area entirely comprising the cell active area, which is the site of the electrochemical reaction and practically coincides with the electrode surface, but not comprising at least part of the peripheral region of the same bipolar plates.

The current-collecting plates with reduced planform of the invention are preferably made of aluminium or copper.

In one preferred embodiment, the current-collecting plates do not comprise any other opening than those optionally used for the passage of the tightening tie-rods; in particular, no openings are present in the current-collecting plates defining channels for the passage of process fluids.

In one preferred embodiment, the current-collecting plates are housed in an appropriate recess obtained in the terminal compression plates.

The stack of the invention may comprise a cooling system of any type known in the art, for instance of the type with coolant recirculating cells intercalated between pairs of adjacent fuel cells, or of the type with direct water injection inside the elementary fuel cells: the only indispensable requirement for achieving the objects of the invention is that the water or other chosen coolant cannot come in contact with the current-collecting plates.

For this purpose, the coolant inlet and outlet nozzles may be advantageously disposed in the two terminal compression plates or on only one of them, preferably the negatively charged one, and in particular in correspondence of a peripheral region of the negatively charged plate not overlapped to the current-collecting plate.

The stack compression plates may be manufactured with various materials, the use of electrically insulating material, for example suitably reinforced plastic materials, being preferred.

The stack of the invention may be advantageously manufactured by adopting a design making the fuel cell bipolar plates reciprocally interchangeable; also the two current-collecting plates are preferably characterised by an equivalent and reciprocally interchangeable design.

The finding of the present invention will be described making reference to the following drawings, having a merely exemplifying purpose:

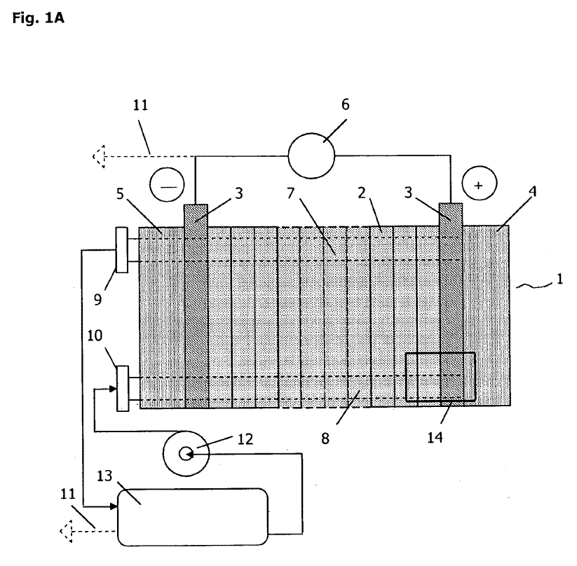

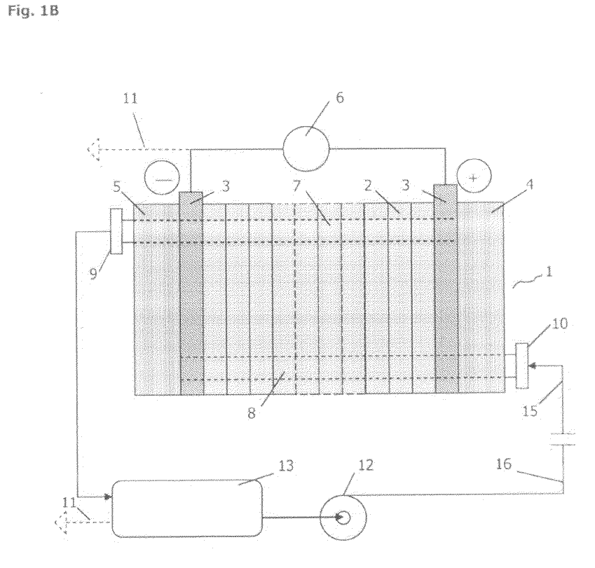

FIG. 1A: scheme of a first embodiment of a system comprising a stack according, to the prior art (side-view of a longitudinal section) and the relevant cooling circuit.

FIG. 1B: scheme of a second embodiment of a system comprising a stack according to the prior art (side-view of a longitudinal section) and the relevant cooling circuit.

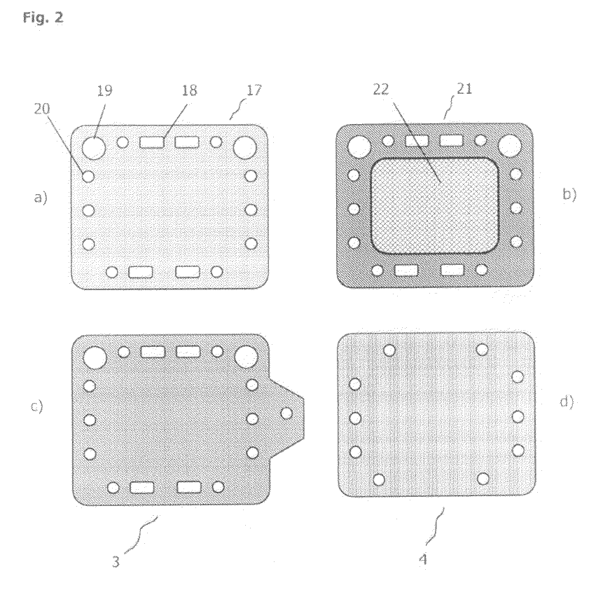

FIG. 2, front-view of some components on the positive terminal side of the stack of FIG. 1A.

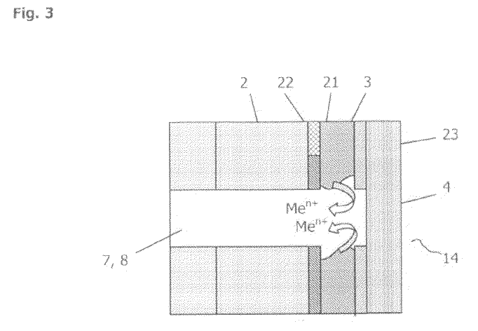

FIG. 3, detail of the stack of FIG. 1A in which there is represented the metal ion release by the positive current-collecting plate.

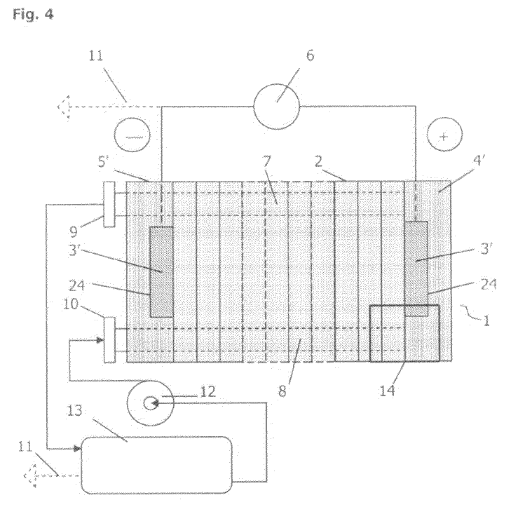

FIG. 4, scheme of a first embodiment of a system comprising a stack according to the invention (side-view of a longitudinal section) and the relevant cooling circuit.

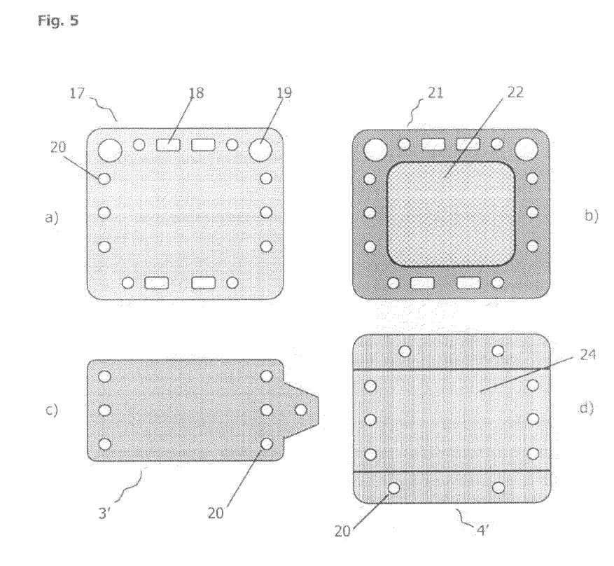

FIG. 5, front-view of some components on the positive terminal side of the stack of FIG. 4.

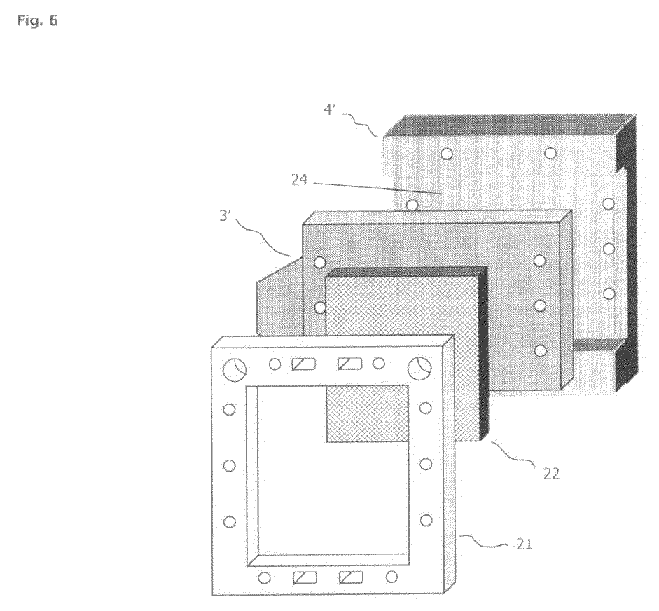

FIG. 6, axonometric view of the components (b), (c) and (d) of FIG. 5.

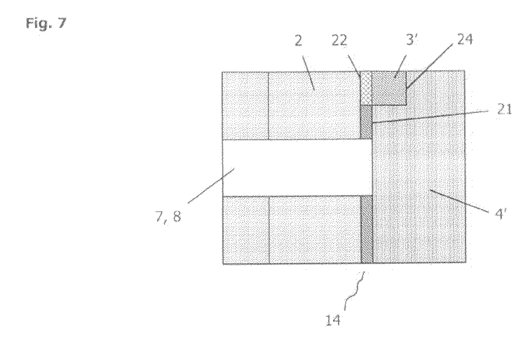

FIG. 7, detail of the stack of FIG. 4.

FIGS. 1A and 1B represent two schemes of electrical energy generation system comprising a fuel cell stack (1) according to the prior art (side-view in section), wherein in particular (2) indicates the elementary cells, (3) the current-collecting plates on the positive and negative terminal side suitable for establishing the connection of the stack to the external circuit, (4) and (5) the compression plates which in co-operation with tie-rods or other mechanical tightening means (not shown) allow maintaining the elementary cells (2) in a suitable electrical series connection, (6) the electrical load of the external circuit consisting for instance of an electric engine in the case of automotive applications or by common electrical household appliances in the case of stationary applications, (7) the internal longitudinal manifold directed to water extraction, (8) the internal longitudinal manifold directed to water feeding, (9) and (10) the connecting nozzles of manifolds (7) and (8) to the external water circulation system, (11) the connections of the electrical circuit on the negative terminal side and of the external water circulation system to ground, (12) the circulating pump, (13) the storage tank of the circulating water, (14) a detail of the stack magnified in the subsequent FIG. 3. In particular, FIGS. 1A and 1B relate to stack designs wherein the two water inlet and outlet nozzles are respectively secured to the same compression plate (for instance the plate on the negative terminal side) or to both plates. In the latter case (FIG. 1B) the water circuit connected to the compression plate on the positive terminal side comprises the two portions (15) and (16) wherein the former, made of electrically insulating material, is dimensioned so as to substantially reduce the stray currents from the positive pole to ground.

The end portion on the positive terminal side of the stack of FIG. 1A is illustrated in detail in FIG. 2, showing the front-view of four components in the assembly sequence toward the exterior, left to right and top to bottom. The components are respectively: (a) the positive bipolar plate (17) of the last elementary cell wherein (18) identifies the feed and extraction openings of the gaseous reactants (typically air and pure or mixed hydrogen), (19) the water feed and extraction openings and (20) the holes for the passage of tie rods, (b) a gasket (21) with a conductive and deformable element (22), for instance a metal foam, housed in the central hollow space, directed to ensure the uniform electrical contact between the bipolar plate (17) and the adjacent current-collecting plate (not shown in FIG. 1A), (c) the current-collecting plate (3) provided with a lateral extension for the electrical connection and with openings and holes corresponding to those of plate (17) and superposable thereto, (d) the compression plate (4) also provided with openings and holes corresponding to those of plate (17) and superposable thereto, preferably made of reinforced plastic material, for instance fibreglass-reinforced polysulphone. Such construction is preferred over the metal type since it allows obtaining a reduction of the stack overall weight particularly appreciated in the automotive field, the suppression of corrosion phenomena due to stray currents, an easier electrical insulation as required for installer and user safety and a better thermal protection of the terminal elementary cells which maintain in this way an operating temperature similar to that of the remaining cells of the stack.

The current-collecting plates must be characterised by negligible ohmic drops in order to minimise the efficiency losses under electrical load and for this reason they have a suitable thickness and are manufactured out of materials characterised by high electrical conductivity, preferably copper or aluminium. The portion on the stack negative terminal side is manufactured likewise.

The outcome of the assemblage of the four components of FIG. 2 in the positive terminal side is represented in FIG. 3, showing the magnification of detail (14) of FIG. 1A, wherein the common elements are identified by the same reference numerals: (2) indicates the terminal elementary cell and (23) the gasket necessarily introduced between plate (4) and current-collecting plate (3) in order to avoid leakage of the water circulating in manifolds (7) and (8). As it is apparent from FIG. 3, the above disclosed assemblage implies the current-collecting plate (3) to be in direct contact with the last elementary cell (2) of the stack and more precisely with the cell positive bipolar plate, normally made of stainless steel or optionally graphite: as it is known to material specialists, the direct contact between two metals of different nature in presence of mildly acidic water as it is the case of the cooling or direct injection water inevitably provokes the corrosion of the weakest of the two metals, in the present case the copper or aluminium of the current-collecting plate (3). To this physiological situations further contributes the electrical potential imposed by the positive terminal bipolar plate of the last cell with a consequent intensification of the deterioration: the corrosive attack entails the loss of material with along term widening of openings (19) and the release of metal ions which accumulate in the circulating water (Cu²⁺ and Al³⁺, generically indicated as Meⁿ⁺). The metal ions are absorbed by the membranes in the points of contact with water: a stack performance decay ensues to the consequent cation conductivity loss in a very short time. Moreover the electrical resistivity of water containing metal ions decreases with a parallel increase of the stray currents, in their turn inducing additional corrosive attacks.

On the stack negative terminal side the current-collecting plate-bipolar plate coupling situation is similar, but for the fact that the potential of the negative terminal bipolar plate of the last cell actually suppresses the corrosive attack or at least decreases the intensity thereof. Nevertheless even on the negative terminal side a corrosion condition is established during the stack shut-downs, when the hydrogen internal self-consumption determines an increase in the electrical potential of the last cell terminal bipolar plate.

FIG. 4 represents a scheme of system comprising a stack in accordance with the invention (side-view of a longitudinal section in the version with both the inlet and outlet nozzles arranged on the same compression plate on the negative terminal side) and the relevant cooling water circuit. The novel elements are represented by the two current-collecting plates (3′) and the compression plates (4′) and (5′), while the remaining elements in common with the systems of the previous figures are indicated by the same reference numerals. In particular, the two compression plates (4′) and (5′) are provided with a recess (24) suitable for housing the adjacent current-collecting plate (3′) which has a reduced planform with respect to the external overall planform of the cell bipolar plates and of the same compression plate. Such planform is however at least coextensive with and superposed to the planform of the elementary cell active area, the latter coinciding with the electrode surface and indicatively equivalent, in one preferred embodiment, to the planform of the deformable conductive element (22).

The components of the portion of stack on the positive terminal side are represented in FIG. 5 according to the assemblage order towards the exterior, left to right and top to bottom: (a) positive bipolar plate (17) of the last elementary cell with (18) identifying the feed and extraction openings of the gaseous reactants (typically air and hydrogen or hydrogen-containing gas), (19) the water feed and extraction openings and (20) the holes for the passage of the tightening tie-rods, (b) gasket (21) with a conductive and deformable element (22), for instance a metal foam, housed in the central hollow space, directed to ensure the uniform electrical contact between the bipolar plate (17) and the adjacent current-collecting plate (not represented in FIG. 4), (c) current-collecting plate of the invention characterised by a reduced planform with respect to the planforms of bipolar plate (17) and of compression plate (3′) and only provided with holes (20) for the passage of tie-rods, (d) compression plate provided with central recess (24) suitable for housing the adjacent current-collecting plate (3′) and only provided with holes (20) for the passage of tie-rods.

For the sake of a better comprehension, FIG. 6 represents the components of FIG. 5 in an axonometric view.

FIG. 7 shows a magnification of the detail (14) of FIG. 4 relative to the extremity of the stack on the positive terminal side wherein (2) indicates the last elementary cell and (3′) a portion of the current-collecting plate housed in the recess (24) of the compression plate (4′) according to the provisions of the invention. FIG. 7 puts in evidence how there is no residual direct contact between the current-collecting plate (3′) and the water circulating in manifolds (7) and (8) formed by juxtaposition of openings (19) of the bipolar plates of the multiplicity of elementary cells: hence the contact between the two different metals of the current-collecting plate (3′) and of the adjacent bipolar plate of the last elementary cell (2) causes no metal ion release. If follows that the inconveniences of the prior art, corrosion and widening of openings (19), metal ion adsorption by the membranes with consequent ionic conductivity drop and stray current increase, are completely suppressed.

FIG. 7 shows also how the terminal gasket (23) necessary with the prior art design can be eliminated, since the function of hydraulic seal to the circulating water is ensured by the sole gasket (21). This of course applies also to the stack extremity on the negative terminal side.

Besides the advantage of decreasing the number of pieces to assemble, the elimination of gaskets (23), together with the insertion of the current-collecting plates within the compression plates, implies a sensible reduction of the length of the stack compared to what is obtainable with the prior art design, a feature particularly useful in the automotive-type applications.

A further characteristic of the invention is given by the fact that the above illustrated advantages are obtained with interchangeable bipolar plates and current-collecting plates, with a consequent simplification and a higher reliability in the stack manufacturing.

The previous description is not intended to limit the invention, which may be used according to different embodiments without departing from the scopes thereof, and whose extent is univocally defined by the appended claims.

Throughout the description and claims of the present application, the term “comprise” and variations thereof such as “comprising” and “comprises” are not intended to exclude the presence of other elements or additives.

1. A stack of elementary fuel cells, each cell being delimited by bipolar plates provided with a first multiplicity of holes for the passage of process fluids and with an optional second multiplicity of holes for the passage of tie-rods, comprising a pair of current-collecting plates and a pair of compression plates, said current-collecting plates positioned externally to the elementary cells in correspondence of the positive and negative terminals, said compression plates located at the two extremities of the stack externally to said current-collecting plates, wherein said current-collecting plates are isolated from said process fluids and said current-collecting plates have a reduced planform with respect to the planform of said bipolar plates and at least coextensive with the elementary cell active area.

2. The stack of claim 1 wherein said current-collecting plates comprise a single multiplicity of holes for the passage of tightening tie-rods matching said second multiplicity of holes of the bipolar plates.

3. The stack of claim 1 wherein at least one of said current-collecting plates is housed in a recess obtained within the corresponding compression plate.

4. The stack of claim 1 wherein the process fluids crossing said first multiplicity of holes of the bipolar plates comprise a coolant.

5. The stack of claim 4 wherein said coolant is water.

6. The stack of claim 4 wherein at least one of said compression plates is provided with inlet and outlet nozzles for said coolant.

7. The stack of claim 6 wherein at least one said compression plates is provided with inlet and outlet nozzles for said coolant.

8. The stack of claim 1 wherein said current-collecting plates are made of copper or aluminum.

9. The stack of claim 1 wherein said compression plates are made of an electrically insulating material.

10. The stack of claim 9 wherein said electrically insulating material is a reinforced plastic material.

11. The stack of claim 1 wherein both the bipolar plates of the elementary cells and the current-collecting plates are interchangeable.

12. (canceled)
